(19) United States
(12) Patent Application Publication
(10) Pub. No.: US 2003/0214624 A1
(43) Pub. Date: Nov. 20, 2003

(54) Liquid crystal display device and optical laminate

(76) Inventors: Takamichi Fujii, Kanagawa (JP); Hiroshi Kawasaki, Kanagawa (JP)

Correspondence Address: BURNS DOANE SWECKER & MATHIS L L P, POST OFFICE BOX 1404, ALEXANDRIA, VA, 22313-1404, US

(21) Appl. No.: 10/332,896

(22) PCT Filed: May 14, 2002
(86) PCT No.: PCT/JP02/04663

(51) Int. Cl. G02F 1/1333

(52) U.S. Cl. 349/158

(57) ABSTRACT

A liquid crystal display device of the present invention, particularly for portable use, is a liquid crystal display device being lightweight, having flexibility, undergoing less breakage and exhibiting excellent color reproducibility and aging stability, and comprising a liquid crystal layer interposed between two substrates each having an electrode, wherein, of those two substrates, at least the substrate in the display face side is a plastic substrate having an optical anisotropy.

### TECHNICAL FIELD

The present invention relates to a liquid crystal display device having a liquid crystal layer interposed between substrates each having an electrode, wherein, of two substrates, at least the substrate in the display face side is composed of a plastic substrate, and also relates to an optical laminate for use in the liquid crystal display device.

### BACKGROUND ART

Glass is an excellent material satisfying the properties required for the substrate of a liquid crystal display device, such as transparency, optical isotropy, gas barrier property, chemical resistance, heat resistance, smoothness and dimensional stability, and is being used as substrates for sandwiching and holding the liquid crystal of a reflection-type liquid crystal device.

However, because of no flexibility and low impact resistance, the glass is scarcely used for the display of portable terminals such as electronic databook and note-type personal computer, and studies are being made to use a plastic substrate in place of the glass substrate, for example, in JP-A-7-13176 (the term “JP-A” as used herein means an “unexamined published Japanese patent application”) and JP-A-10-142588. However, the liquid crystal display devices described in these patent publications suffer from insufficient color reproduction and insufficient stability of performance in aging and have a problem in the angle of visibility, reflection of an outside image and the like.

An object of the present invention is to provide a reflection-type liquid crystal display device particularly for portable use, which is a liquid crystal display device being lightweight, having flexibility and undergoing less breakage.

Another object of the present invention is to provide an optical laminate in the display side so as to attain the above-described object.

### DISCLOSURE OF THE INVENTION

These objects of the present invention can be attained by the liquid crystal display devices of the following (1) to (16) and the optical laminates of (17) and (18).

(1) A liquid crystal display device comprising: a liquid crystal layer; and two substrates each having an electrode, in which the liquid crystal layer is interposed between the two substrates, wherein at least the substrate in the display face side is a plastic substrate having an optical anisotropy.

(2) The liquid crystal display device as described in the item (1), wherein the plastic substrate having optical anisotropy has a function as a phase difference plate.

(3) The liquid crystal display device as described in the item (2), wherein the phase difference plate is a λ/4 plate.

(4) The liquid crystal display device as described in the item (3), wherein the λ/4 plate has the retardation value (Re450) of from 60 to 135 nm which is measured at a wavelength of 450 nm, the λ/4 plate has the retardation value (Re590) of from 100 to 170 nm which is measured at a wavelength of 590 nm, and the λ/4 plate satisfy the relationship of Re590−Re450≧2 nm.

(5) The liquid crystal display device as described in any one of items (1) to (4), which further comprises a polarizing plate, in which the polarizing plate is laminated to the plastic substrate having an optical anisotropy.

(6) The liquid crystal display device as described in any one of the items (1) to (5) , wherein the electrode on the plastic substrate having an optical anisotropy in the display face side is a transparent electrode.

(7) The liquid crystal display device as described in any one of the items (1) to (6), which further comprises a gas barrier layer, in which the gas barrier layer is provided on the plastic substrate having an optical anisotropy in the display face side.

(8) The liquid crystal display device as described in any one of the items (1) to (7), which further comprises a color filter layer, in which the color filter layer is provided on the plastic substrate having an optical anisotropy in the display face side.

(9) The liquid crystal display device as described in any one of the items (1) to (7), which further comprises a color filter layer, in which the color filter layer is provided on the substrate on the opposite side of the display face.

(10) The liquid crystal display device as described in the item (9), wherein the color filter layer is provided on a driving circuit.

(11) The liquid crystal display device as described in any one of the items (1) to (10), wherein the outermost layer in the display face side is subjected to at least one of an antireflection treatment and an antiglare treatment.

(12) The liquid crystal display device as described in the item (8), wherein the color filter layer is provided between the polarizing plate and the transparent electrode.

(13) The liquid crystal display device as described in the item (7), wherein the gas barrier layer is provided in the side closer to the liquid crystal layer than one of a circularly polarizing plate and a color filter.

(14) The liquid crystal display device as described in any one of the items (1) to (5), wherein a transparent electrode, a gas barrier layer, a color filter layer and at least one of an antireflection and antiglare layer are provided on the plastic substrate having an optical anisotropy in the display face side.

(15) The liquid crystal display device as described in the item (14), wherein all layers in the side closer to the display face than the liquid crystal layer have a thickness of 0.1 to 1.0 mm in total.

(16) The liquid crystal display device as described in any one of the items (1) to (15), which is a reflection-type liquid crystal display device, wherein the electrode on the opposite side of the display face is a reflective electrode.

(17) An optical laminate comprising a plastic substrate having thereon at least a color filter layer, said plastic substrate having an optical anisotropy.

(18) The optical laminate as described in the item (17), which further comprises at least one of an electrode, a gas barrier layer, at least one of an antireflection layer and an antiglare layer, and a polarizing element.

### BRIEF DESCRIPTION OF THE DRAWINGS

FIG. 1 is a cross-sectional view showing the construction of a liquid crystal display device manufactured in Example 1 of the present invention.

FIG. 2 is a cross-sectional view showing the construction of a liquid crystal display device manufactured in Example 2 of the present invention.

FIG. 3 is a cross-sectional view showing the construction of a liquid crystal display device manufactured in Example 3 of the present invention.

FIG. 4 is a cross-sectional view showing the construction of a liquid crystal display device manufactured in Example 1 of the present invention.

FIG. 5 is a plan view showing the substrate obtained by laminating a large-size plastic substrate and a large-size glass substrate.

FIG. 6 is a schematic view showing the cutting step of liquid crystal cells.

### DESCRIPTION OF NUMERICAL REFERENCES

Description of Numerical References:

| | |
|---|---|
| 1 | antireflection layer/antiglare layer |
| 2 | protective film |
| 3 | polarizing element |
| 4 | λ/4 plate |
| 5 | color filter |
| 6 | gas barrier film |
| 7 | transparent electrically conducting film |
| 8 | orientation film |
| 9 | liquid crystal layer |
| 10 | reflective electrode |
| 11 | lower glass substrate with driving circuit |
| 12 | polarizing plate |
| 13 | plastic substrate |
| 14 | sealing agent |
| 15 | picture plane part |
| 16 | glass substrate |
| 17 | liquid crystal layer |
| 18 | cutting grindstone |

The liquid crystal display device of the present invention is not particularly limited on the mode but is preferably TN (twisted nematic) type, VA (vertical alignment) type, HAN (hybrid aligned nematic) type, STN (super twisted nematic) type or GH (guest host) type. Also, the liquid crystal display device of the present invention is not limited to any of a transmission-type liquid crystal device, an semi-transmission-type liquid crystal device and a reflection-type liquid crystal device, but is preferably a reflection-type liquid crystal device.

The twist angle of the TN-type liquid crystal cell is preferably from 40 to 100°, more preferably from 50 to 90°, and most preferably from 60 to 80°. The product (Δnd) of the refractive index anisotropy (Δn) of the liquid crystal layer and the thickness (d) of the liquid crystal layer is preferably from 0.1 to 0.5 μm, more preferably from 0.2 to 0.4 μm. The TN-type liquid crystal cell may be used in a simple matrix system having no driving circuit or in an active matrix system having a driving circuit but is preferably used in the active matrix system.

The twist angle of the STN-type liquid crystal cell is preferably from 180 to 360°, more preferably from 220 to 270°. The product (Δnd) of the refractive index anisotropy (Δn) of the liquid crystal layer and the thickness (d) of the liquid crystal layer is preferably from 0.3 to 1.2 μm, more preferably from 0.5 to 1.0 μm. The STN-type liquid crystal cell can be used in a simple matrix system having no driving circuit or in an active matrix system having a driving circuit.

In the HAN-type liquid crystal cell, it is preferred that the liquid crystal on one substrate is substantially perpendicularly oriented and the pretilt angle on another substrate is from 0 to 45°. The product (Δnd) of the refractive index anisotropy (Δn) of the liquid crystal layer and the thickness (d) of the liquid crystal layer is preferably from 0.1 to 1.0 μm, more preferably from 0.3 to 0.8 μm. The substrate on which liquid crystal is perpendicularly oriented may be the substrate in the reflecting plate side or the substrate in the transparent electrode side.

In the GH-type liquid crystal cell, the liquid crystal layer comprises a mixture of a liquid crystal and a dichroic dye. In the case where the liquid crystal and the dichroic dye both are a bar-like compound, the director of the liquid crystal runs in parallel to the long axis direction of the dichroic dye. When the orientated state of the liquid crystal changes upon application of a voltage, the dichroic dye also undergoes change in the long axis direction similarly to the liquid crystal. As for the GH-type liquid crystal cell, a Heilmeir type, a White-Taylor type using cholesteric liquid crystal, a two-layer type and a system using a λ/4 plate are known. In the present invention, the system using a λ/4 plate is preferably used. The guest host reflection-type liquid crystal device equipped with λ/4 plate is described in JP-A-6-222350, JP-A-8-36174, JP-A-10-268300, JP-A-10-292175, JP-A-10-293301, JP-A-10-311976, JP-A-10-319442, JP-A-10-325953, JP-A-10-333138 and JP-A-11-38410. The λ/4 plate is provided between the liquid crystal layer and the reflecting plate. The liquid crystal layer may have horizontal orientation or perpendicular orientation but preferably has perpendicular orientation. The dielectric constant anisotropy of the liquid crystal is preferably negative.

The reflection-type liquid crystal display device may be used either in a normally white mode of giving bright display at a low applied voltage and dark display at a high applied voltage or in a normally black mode of giving dark display at a low applied voltage and bright display at a high applied voltage, but is preferably used in a normally white mode.

The driving system for the liquid crystal display device of the present invention is preferably an active matrix system rather than a simple matrix system and more preferably uses TFT (thin film transistor), TFD (thin film diode) or MIM (metal insulator metal). In the case of TFT, a low-temperature polysilicon is preferably used.

These are described in detail in Ekisho Device Handbook (Handbook of Liquid Crystal Devices), compiled by Nippon Gakujutsu Shinko Kai Dai 142 Iinkai, issued by Nikkan Kogyo Shinbun Sha; Mitsuharu Okano et al., Ekisho Oyo-hen (Liquid Crystal, Application), Baifu Kan; Shunsuke Kobayashi et al., Color Ekisho Display (Color Liquid Crystal Display), Sangyo Tosho; Tatsuo Uchida, Jisedai Ekisho Display Gijutsu (Technology of Next Generation Liquid Crystal Display), Sigma Shuppan; and Ekisho: LCD no Koso to Atarashii Oyo (Liquid Crystal: Elementary and New Application of LCD), compiled by Ekisho Wakate Kenkyu Kai, issued by Sigma Shuppan.

[Plastic Substrate Having Optical Anisotropy]

In the liquid crystal display device, the substrate plays an important role of sandwiching and holding a liquid crystal having fluidity and maintaining the shape of the liquid crystal cell. The reflection-type liquid crystal display device of the present invention uses a plastic substrate in the display side and the plastic substrate must have optical anisotropy, high transmittance to visible light, thermal and dynamic stability, flexibility and strength large enough to support the liquid crystal display device. The optical anisotropy as used in the present invention means to have birefringent property. The plastic substrate having optical anisotropy for use in the present invention is preferably a plastic substrate having a function as a phase difference plate, more preferably a plastic substrate where the phase difference of birefringent light is λ/2 wavelength or λ/4 wavelength as described later.

In the present invention, the plastic substrate may be laminated with another polarizing plate and may further have a gas barrier layer, a transparent electrode, an antireflection or antiglare layer, a color filter layer and the like.

In the present invention, the plastic substrate is used at least for the substrate in the display face side, and the substrate in the opposite side may be a plastic substrate or a glass substrate. In a preferred embodiment, the plastic substrate is used also in the opposite side.

Examples of the plastic of the plastic substrate for use in the present invention include polyvinyl alcohol-base resins, polycarbonate derivatives (e.g., Modified, Copolymerized Polycarbonate, produced by Teijin Limited), cellulose derivatives (e.g., cellulose triacetate, cellulose diacetate), polyolefin-base resins (e.g., ZEONOA, ZEONEX, produced by Nippon Zeon), polysulfone-base resins, polyether sulfone, norbornene-base resins (e.g., ARTON, produced by JSR), polyester-base resins (e.g., PET, PEN), polyimide-base resins, polyamide-base resins, polyarylate-base resins and polyether ketone. Among these, preferred are polycarbonate derivatives, cellulose derivatives, polyolefin-base resins and norbornene-base resins, more preferred are polycarbonate derivatives.

The thickness of the plastic substrate for use in the present invention is preferably from 0.05 to 1.00 mm, more preferably from 0.1 to 1.00 mm.

The glass substrate may be a soda lime glass or a non-alkali glass. On the glass substrate, other layers such as reflective electrode or driving circuit may be formed. The thickness of the glass substrate is preferably from 0.1 to 1.0 mm, more preferably from 0.2 to 0.8 mm.

The sealing agent is used for holding the liquid crystal and the formation method and construction material therefor are not particularly limited. The sealing agent is preferably formed by a printing method or a dispenser method and the construction material therefor is preferably a thermoplastic resin or a UV-curable resin.

[Polarizing Plate]

The polarizing plate for use in the present invention may be a commercially available polarizing plate or a conventional polarizing plate where the above-described plastic substrate is used in place of the protective film. The polarizing element of the polarizing plate may be manufactured by any of a method of dissolving or adsorbing dichroic molecules such as iodine or dye and stretching the film in one direction to orient the dichroic molecules, a method of adsorbing the above-described dichroic molecules on a monoaxially stretched film, a method of using a dichroic dye containing a water-soluble organic dye such as a bisazo compound, its tautomer or a salt thereof, and a method of using a water-soluble compound selected from a bistriazine compound, its tautomer and a salt thereof.

From the standpoint of elevating the contrast of the liquid crystal display device, the polarizing plate for use in the present invention preferably has a high transmittance and a high polarization degree. The transmittance at 550 nm is preferably 30% or more, more preferably 40% or more. The polarization degree at 550 nm is preferably 95.0% or more, more preferably 99% or more, still more preferably 99.9% or more.

The film for use in the present invention where the transmission axis of the polarizing plate is inclined at a preferred angle of 40 to 50° with respect to the longitudinal direction can be obtained by holding both ends of a polymer film continuously fed using holding means, imparting a tension while allowing the holding means to proceed in the longitudinal direction of the film, stretching the film under the conditions such that the locus L1 of the holding means from the point of substantially initiating the holding of one end of the polymer film until the point of substantially releasing the holding, the locus L2 from the point of substantially initiating the holding of another end of the polymer film until the point of substantially releasing the holding and the distance W between two points of substantially releasing the holding satisfy the following formula (1), the polymer film maintains the supporting property and the volatile partial ratio is 5% or more, and then shrinking the film to reduce the volatile partial ratio:

|L2−L1|>0.4W Formula (1)

The polarizing plate having such an inclination angle can be laminated to the liquid crystal cell as it is in the production of the reflection-type liquid crystal display device of the present invention and the polarizing plate needs not be cut out obliquely as in conventional techniques. Thus, the polarizing plate can be effectively used.

[Circularly Polarizing Plate]

When the plastic substrate having optical anisotropy for use in the present invention is a λ/4 phase difference plate and combined with the above-described polarizing plate, the polarizing plate is a circularly polarizing plate. Also, the plastic substrate for use in the present invention can have a function as the polarizing plate or another λ/4 plate can be laminated to the plastic substrate.

[λ/4 Plate]

The λ/4 plate for use in the liquid crystal display device of the present invention or the case where the plastic substrate having optical anisotropy functions as the λ/4 plate is described. The λ/4 plate is preferably a monoaxially stretched polymer film or the above-described plastic substrate which is rendered to have a function as a λ/4 plate by coating liquid crystal or the like.

The λ/4 plate for use in the present invention is preferably λ/4 over a wide wavelength region, more specifically, the retardation value (Re450) measured at a wavelength of 450 nm is from 60 to 135 nm, more preferably from 108 to 120 nm, the retardation value (Re590) measured at a wavelength of 590 nm is from 100 to 170 nm, and these retardation values satisfy the relationship of Re590−Re450≧2 nm, more preferably Re590−Re450≧5 nm, most preferably Re590−Re450≧10 nm.

The retardation value (Re) is calculated according to the following formula:

Retardation value (Re)=(nx−ny)×d

wherein nx is a refractive index in the direction of the lagging axis in the plane of the phase difference plate (in-plane maximum refractive index); ny is a refractive index in the direction perpendicular to the lagging axis in the plane of the phase difference plate; and d is the thickness (nm) of the phase difference plate.

Preferred examples of the resin which is monoaxially stretched and thereby constitutes the λ/4 plate include polyvinyl alcohol-base resins, polycarbonate, polycarbonate derivatives (e.g., modified, copolymerized polycarbonate, produced by Teijin Limited), cellulose derivatives (e.g., cellulose triacetate, cellulose diacetate), polyolefin-base resins (e.g., ZEONOA, ZEONEX, produced by Nippon Zeon), polysulfone-base resins, polyether sulfone, norbornene-base resins (e.g., ARTON, produced by JSR), polyester-base resins (e.g., PET, PEN), polyimide-base resins, polyamide-base resins, polyarylate-base resins, polyether ketone and polystyrene.

Particularly, a monoaxially stretched polycarbonate derivative, cellulose derivative or polyolefin-base resin (see, WO00/6584) is preferably used as it is as the plastic substrate. Such a resin is more preferably used by laminating it with the plastic substrate.

The λ/4 plate may also be obtained by providing an orientation film comprising a polyvinyl alcohol derivative or a polyimide derivative on the plastic substrate and after applying a rubbing treatment, coating a discotic liquid crystal or a bar-like liquid crystal to form a nematic liquid crystal phase.

In the case where the reflection-type liquid crystal display device of the present invention is in the VA type mode, use of a λ/4 plate having a lagging axis inclined at 45° with respect to the longitudinal direction is preferred because the λ/4 plate can be effectively used.

In the case where the phase difference plate is used as a λ/2 plate, the retardation value (Re450) measured at a wavelength of 450 nm is from 200 to 250 nm, the retardation value (Re590) measured at a wavelength of 590 nm is from 240 to 320 nm, and these retardation values satisfy the relationship of Re590−Re450≧4 nm, more preferably Re590−Re450≧−10 nm, most preferably Re590−Re450≧20 nm.

It is preferred that the retardation value (Re450) measured at a wavelength of 450 nm is from 216 to 240 nm, the retardation value (Re550) measured at a wavelength of 550 nm is from 250 to 284 nm, the retardation value (Re590) measured at a wavelength of 590 nm is from 260 to 304 nm and these retardation values satisfy the relationship of Re590−Re550≧4 nm, more preferably Re590−Re550≧10 nm, most preferably Re590−Re550≧20 nm. It is also preferred that the retardation values satisfy the relationship of Re550−Re450≧20 nm. The materials and the like are the same as those for the λ/4 plate.

[Transparent Electrode]

The transparent electrode used on the plastic substrate preferably has a surface resistivity of 10³ Ω/□ or less, more preferably 100 Ω/□ or less.

For setting the surface resistivity of the transparent electrode to fall within the above-described range, a method of coating an electrically conducting fine particle dispersion or metal alkoxide, a vacuum film-forming method such as sputtering, vacuum vapor deposition, ion plating and CVD, or a vapor phase growth method is preferably used.

Examples of the material for the transparent electrode include metal oxides such as In₂O₃ type (including those doped with Sn or the like), SnO₂ type (including those doped with F, Sb or the like) , ZnO type (including those doped with Al, Ga or the like), TiO₂, Al₂O₃, SiO₂, MgO, BaO, MoO₃ and V₂O₅, composites thereof such as In₂O₃—ZnO type, and metal nitrides such as TiN.

As for the method of forming a film mainly comprising indium oxide by sputtering, the reactive sputtering may be performed using a metal target mainly comprising indium or using a target which is a sintered body mainly comprising indium oxide. In view of the control of reaction, the latter is preferred. In the reactive sputtering, an inert gas such as argon is used as the sputtering gas and oxygen is used as the reactive gas. As for the discharge form, DC magnetron sputtering, RF magnetron sputtering and the like may be used. The flow rate of oxygen is preferably controlled by a plasma emission monitor method.

[Gas Barrier Layer]

In the present invention, the gas barrier layer prevents water, organic materials, air and the like from entering through the plastic substrate or a color filter to change the liquid crystal state and deteriorate the durability of the liquid crystal display device.

Accordingly, the gas barrier layer preferably comprises a material having low permeability to water, organic materials, air and the like, for example, an inorganic oxide such as silicon oxide, metal oxide, non-metal oxide and submetal oxide.

The gas barrier layer is preferably present between the λ/4 plate and the transparent electrode or between the color filter and the transparent electrode

The silicon oxide as used in the present invention is an oxide of Si, such as SiO and SiO₂, and is represented by SiOx. In view of the gas barrier property, transparency, surface smoothness, bending property and the like, a metal oxide mainly comprising a silicon oxide where the ratio of the oxygen atom number to the silicon atom number is from 1.5 to 2.0, is preferred. The ratio of the oxygen atom number to the silicon oxide can be analyzed and determined by an X-ray electron spectrometry, an X-ray micro-spectrometry, Auger electron spectrometry, Rutherford backscattering spectrometry or the like. If this ratio is less than 1.5, bad transparency results. Therefore, the ratio is preferably from 1.5 to 2.0.

Specific preferred examples of the material for the gas barrier layer include aluminum oxide, zinc oxide, antimony oxide, indium oxide, calcium oxide, cadmium oxide, silver oxide, gold oxide, chromium oxide, silicon oxide, cobalt oxide, zirconium oxide, tin oxide, titanium oxide, iron oxide, copper oxide, nickel oxide, platinum oxide, palladium oxide, bismuth oxide, magnesium oxide, manganese oxide, molybdenum oxide, vanadium oxide and barium oxide. Among these, silicon oxide and aluminum oxide are more preferred because these have both high barrier property to oxygen and water vapor and high transparency and at the same time, these are industrially inexpensive.

These silicon oxide and aluminum oxide may be used individually or in combination. The metal oxide may contain trace metal, non-metal or submetal in the element form or for the purpose of improving the plasticity, may appropriately contain carbon, fluorine or magnesium fluoride.

The thickness of the metal oxide layer is preferably from 5 to 200 nm. If the thickness is less than 5 nm, formation of a uniform film is difficult and the film may not be formed in some portions to allow a gas to permeate therethrough, giving rise to bad gas barrier property. On the other hand, if the thickness exceeds 200 nm, not only the transparency is lost but also cracks are readily generated to impair the gas barrier property.

In the present invention, sputtering is mainly used. In the sputtering for forming, for example, a layer containing a silicon oxide SiOx, a sintered body mainly comprising silicon or silicon oxide can be used as the target. In the former case, the reactive sputtering is performed by introducing an inert gas such as argon and a reactive gas such as oxygen gas into a vacuum tank. In the latter case, the sputtering is performed using an inert gas such as argon, having mixed therein a trace amount of reactive gas such as oxygen gas. As for the sputtering system, a known system may be employed, such as direct current or high frequency bipolar sputtering, direct current or high frequency magnetron sputtering, and ion beam sputtering. Among these, magnetron system is preferred because plasma impact against the substrate is small and high-speed film formation can be attained. In the present invention, the film formation is preferably performed using an Si metal target by direct current magnetron sputtering so as to increase the film formation speed. In some cases, an Si oxide target is used but this is not preferred in view of productivity because the film formation speed is extremely low and the discharge stability is bad.

As for the sputtering apparatus, a roll-to-roll system is preferred in view of the productivity but a batch system can also be used.

[Color Filter Layer]

The color filter layer for use in the present invention is preferably formed, for example, by a dye method, a pigment dispersion method, a printing method, an electron deposition method or a spin coating method. The color filter layer is more preferably formed by a transfer method using a photosensitive transfer material described in JP-A-5-80503, a photographic method using a silver halide color light-sensitive material described in JP-A-7-294714, or a laser method using an image formation system described in JP-A-7-290731.

The color filter layer may be provided between the λ/4 plate and the gas barrier layer, or the λ/4 plate, the gas barrier layer and the color filter layer may be provided in this order.

The color filter layer for use in the present invention is preferably provided on a plastic substrate in the display side or on a driving circuit in the opposite side.

[Antireflection/Antiglare Layer]

The antireflection/antiglare layer for use in the present invention is preferably an antireflection layer by a thin film interference layer. The antiglare layer is preferably a scattering layer having irregularities on the surface or containing in the inside thereof particles different in the refractive index.

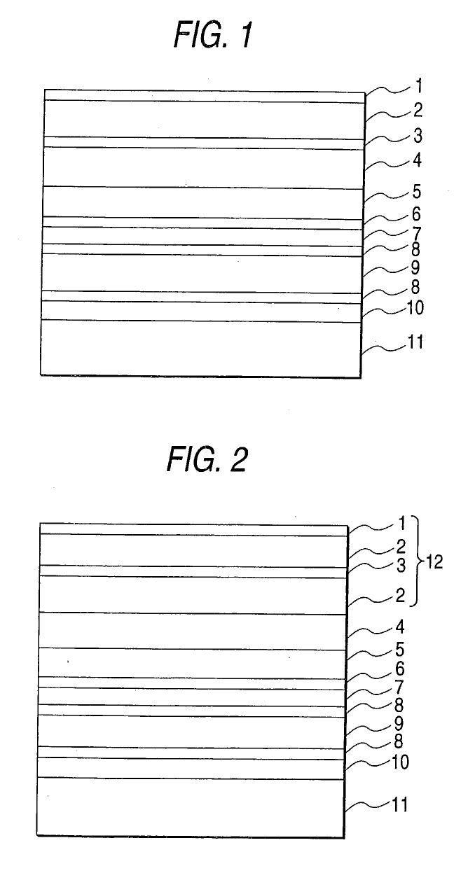

JP-B-60-59250 (the term “JP-B” as used herein means an “examined Japanese patent publication”) discloses an antireflection layer having fine holes and a fine particulate inorganic material. JP-A-59-50401 discloses an antireflection film obtained by laminating a high refractive index layer and a low refractive index layer in this order. This patent publication also discloses an antireflection film where a medium refractive index layer is provided between the support and the high refractive index layer. The low refractive index layer is formed by coating polymer or inorganic fine particles. JP-A-2-245702 discloses an antireflection film where two or more kinds of ultrafine particles (for example, MgF₂ and SiO₂) are present in mixture and the mixing ratio thereof is changed in the film thickness direction. By changing the mixing ratio, the refractive index is changed and the same optical property as that of the antireflection film comprising a high refractive index layer and a low refractive index layer described in JP-A-59-50401 above, can be obtained. The ultrafine particles are bonded by SiO₂ generated upon thermal decomposition of ethyl silicate. Upon thermal decomposition of ethyl silicate, carbon dioxide and water vapor are also generated by the combustion of ethyl moiety. As shown in FIG. 1 of JP-A-2-245702, carbon dioxide and water vapor desorb from the layer and thereby, a void is generated between ultrafine particles.

JP-A-5-13021 discloses a technique of filling a binder into the void between ultrafine particles present in the antireflection film described in JP-A-2-245702 above. JP-A-7-48527 discloses an antireflection film containing a binder and an inorganic fine powder comprising porous silica. JP-A-2001-100004 discloses a method for forming an antiglare antireflection film having at least one low refractive index layer containing a fluorine-containing resin having a refractive index of 1.38 to 1.49, wherein an antiglare layer containing a binder having a refractive index of 1.57 to 2.00 is provided between the substrate and the low refractive index layer.

The antireflection/antiglare layer for use in the present invention may be sufficient if it is constructed by providing the antiglare layer and the low refractive index layer in this order on the substrate. As for the low refractive index layer, a hard coat layer is preferably further provided between specified refractive index layers and two or more hard coat layers different in the constituent components may also be provided.

The antireflection/antiglare layer for use in the present invention is preferably formed on the outermost surface of the plastic substrate.

In the production of a liquid crystal cell using the substrate for use in the present invention, one liquid. crystal cell is produced from a pair of substrates. More specifically, the liquid crystal cell is produced by subjecting a glass substrate with a color filter and/or ITO to an electrode patterning step, an orientation film orientating step, an assembling step, a cell formation step and the like. Particularly, the procedure from the assembling step to the cell formation step includes a step of forming a seal, spreading a spacer, laminating the substrates, curing the sealing agent, cutting the substrate into an appropriate size and injecting liquid crystal into each cell, a step of adjusting the cell thickness, a step of sealing the liquid crystal, cutting, and laminating a polarizing plate. It is not efficient to perform this procedure every each production of one liquid crystal cell. The productivity must be elevated. In the case of laminating a polarizing plate by such a procedure to a liquid crystal cell comprising a plastic film substrate, the liquid crystal cell may be broken at the lamination to cause reduction in the yield, or a polarizing plate must be laminated to each liquid crystal cell (panel) and this is inefficient. Therefore, the liquid crystal cell is preferably produced by a method where a display face side plastic substrate equipped with electrodes and orientation films necessary for manufacturing a plurality of liquid crystal cells is paired with an opposite side glass or plastic substrate, these substrates are laminated through a spacer, the substrate is cut into individual liquid crystal cell units, and liquid crystal is injected into each liquid crystal cell and sealed, or a method where a display face side plastic substrate equipped with electrodes and orientation films necessary for manufacturing a plurality of liquid crystal cells is paired with the opposite side glass or plastic substrate, these substrates are laminated through a spacer, liquid crystal is injected and sealed, and then the substrate is cut into individual liquid crystal cell units.

These preferred production methods of liquid crystal cell are described below.

In these production methods of liquid crystal cell (panel), the substrate at least in the display face side is a plastic substrate having optical anisotropy. The substrate in the opposite side may be a plastic substrate or a glass substrate. On the paired two substrates in the display surface side and in the opposite side, an orientation film is usually coated and subjected to a rubbing treatment. Each substrate has a size necessary for obtaining a plurality of liquid crystal cells. For example, in order to obtain a 13.3-inch liquid crystal cell, a substrate of 360 mm×465 mm, 550 mm×650 mm, 600 mm×720 mm, 650 mm×830 mm or 900 mm×1,100 mm may be used. Furthermore, a plastic substrate longer than these, for example, a rolled plastic substrate may also be used.

In these production methods, a sealing agent for fixing two substrates and holding liquid crystal is coated in a rectangular frame form on one substrate in the display face side or in the opposite side. The sealing agent is coated in accordance with the size and number of liquid crystal cells after the cutting and at the coating, at least one port for injecting liquid crystal is provided. After spreading spacers on another substrate for maintaining the cell gap, two substrates are laminated to each other and then the sealing agent is cured. Thereafter, liquid crystal is injected from the injection port and at the sealing step, the injection port is closed. The liquid crystal injection step and the sealing step may be performed after the cutting step described below.

In the case where the plastic substrate in the display face side has a function as a polarizing plate or a circularly polarizing plate, the substrate obtained by laminating two substrates is cut into a predetermined cell (panel) size to manufacture a plurality of liquid crystal cells.

In the case where the plastic substrate in the display face side does not have a function as a polarizing plate or a circularly polarizing plate, a polarizing plate or a circularly polarizing plate is laminated thereto and the substrate obtained by laminating two substrates is cut into a predetermined panel size to manufacture a plurality of liquid crystal cells.

For obtaining a larger number of liquid crystal cells from one pair of substrates, the liquid crystal may be injected after the above-described cutting step, from the previously provided liquid crystal injection port and sealed to obtain liquid crystal cells.

In the present invention, the cutting step is in either case preferably performed after laminating upper and lower substrates each in a size large enough to obtain a plurality of liquid crystal cells and imparting thereto a function as a polarizing plate or a circularly polarizing plate.

The number of liquid crystal cells obtained by the cutting varies depending on the substrate size and the panel size but it is preferred to obtain 2 or more panels, more preferably 4 or more panels, most preferably 100 or more panels, from a pair of substrates. In view of strength and precision, the upper limit is about 300 panels, preferably about 200 panels.

In these production methods of liquid crystal cell, the cutting step is performed after the lamination step, whereby a plurality of liquid crystal cells can be efficiently obtained from large-size substrates. Furthermore, a polarizing plate or a circularly polarizing plate is laminated to one or both of the substrates before the cutting step, whereby the liquid crystal cell can be prevented from breakage by the lamination of a polarizing plate after the cutting. In the case where the plastic substrate has a function as a polarizing plate or a circularly polarizing plate, the step of laminating a polarizing plate or a circularly polarizing plate as in conventional techniques can be omitted and the production can be more efficiently performed.

The liquid crystal is sealed using a sealing agent between a plastic substrate and a glass substrate each having a size larger than the desired size and after cutting the plastic substrate in the display face side and at the same time, scribing the glass substrate, the substrate is cut and divided, whereby liquid crystal cells in a desired size can be produced. In the cutting into liquid crystal cells, the sealing agent portion is preferably cut so as not to allow the liquid crystal to leak out after the cutting.

The cutting of the plastic substrate and the scribing on the glass substrate may be performed using a cutting grindstone described in JP-A-7-263268, by a laser processing system described in JP-A-2001-21904, by a multi-wire saw described in JP-A-5-96361, by a rotary blade described in JP-A-5-249441, or by a cutter. The cutting by a cutting grindstone is preferred.

The depth of scratch on the glass surface by the scribing is preferably from 0.1 to 300 μm, more preferably from 1 to 100 μm, still more preferably from 5 to 30 μm.

After simultaneously performing the cutting of plastic substrate and the scribing of glass surface, the cutting into a plurality of liquid crystal cells is preferably performed by applying a pressure to the scratch on the glass surface to transmit the stress from the glass surface to the opposite side and thereby cutting and dividing the glass substrate.

The cutting of the plastic substrate and the scribing of the glass substrate are preferably performed at the same time. More preferably, one cutting apparatus can cut the plastic substrate and scribe the glass substrate by a continuous operation. The cutting and dividing of the glass substrate may be performed separately from or simultaneously with the cutting of the plastic substrate and the scribing of the glass substrate, but is preferably performed simultaneously therewith.

### BEST MODE FOR CARRYING OUT THE INVENTION

The present invention is described in detail below by referring to Examples, however, the present invention should not be construed as being limited thereto.

### EXAMPLE 1

(Manufacture of Polarizing Element)

A PVA film was dipped in an aqueous solution containing 1.0 g/liter of iodine and 60.0 g/liter of potassium iodide at 25° C. for 30 seconds, further dipped in an aqueous solution containing 40 g/liter of boric acid and 30 g/liter of potassium iodide at 25° C. for 120 seconds, introduced into a tenter for stretching the film in the direction of inclining the absorption axis at 45° with respect to the longitudinal direction, stretched to 2 times in an atmosphere of 60° C. and 90%, subjected to repeated bending and shrinking of the tenter in the stretching direction, dried in an atmosphere of 80° C. and taken out from the tenter. The water content of the PVA film was 31% before the initiation of stretching and 1.5% after the drying.

The difference in the transportation speed between left and right tenter clips was less than 0.05% and the angle made by the center line of the film introduced and the center line of the film delivered to the next step was 0°. Here, |L1−L2| was 0.7 m and W was 0.7 m, accordingly, the relationship of |L1−L2|=W was established. The substantial stretching direction at the tenter outlet was inclined at 45° with respect to the center line of the film delivered to the next step. At the tenter outlet, wrinkling or film deformation was not observed. Thus, a polarizing element having an absorption axis inclined at 45° with respect to the longitudinal direction by the stretching was manufactured.

(Manufacture of Plastic Substrate in the Display Face Side)

A coating solution according to the following formulation H1 was coated on a 100 μm-thick polyethylene terephthalate film temporary support and dried to provide a thermoplastic resin layer having a dry film thickness of 20 μm.

Formulation H1 for Thermoplastic Resin Layer:

15 Parts by weight of methyl methacrylate/2-ethylhexyl acrylate/benzyl methacrylate/methacrylic acid copolymer (copolymerization compositional ratio (by mol)=55/28.8/11.7/4.5, weight average molecular weight: 90,000), 6.5 parts by weight of polypropylene glycol diacrylate (average molecular weight: 822), 1.5 parts by weight of tetraethylene glycol dimethacrylate, 0.5 parts by weight of p-toluenesulfonamide, 1.0 part by weight of benzophenone and 30 parts by weight of methyl ethyl ketone.

On the thermoplastic resin layer, a coating solution according to the following formulation Bi was coated and dried to provide an interlayer having a dry film thickness of 1.6 μm.

Formulation B1 for Interlayer:

130 Parts by weight of polyvinyl alcohol (PVA 205, produced by Kuraray Co., Ltd., saponification degree: 80%), 60 parts by weight of polyvinylpyrrolidone (PVP, K-90 produced by GAF Corporation), 10 parts by weight of fluorine-containing surfactant (Surflon S-131, produced by Asahi Glass Co., Ltd.) and 3,350 parts by weight of distilled water.

On 4 sheets of the thus-obtained temporary support having the thermoplastic layer and the interlayer, photosensitive solutions of 4 colors of black (for B1 layer), red (for R layer), green (for G layer) and blue (for B layer) were coated, respectively, and dried to form a colored photosensitive resin layer having a dry film thickness of 2 μm.

On the photosensitive resin layer, polypropylene covering sheet (thickness: 12 μm) was press-bonded. Thus, red, blue, green and black photosensitive transfer materials were prepared.

Using these photosensitive transfer materials, a color filter was manufactured as follows. The covering sheet of the red photosensitive transfer material was peeled off and the photosensitive resin layer surface was laminated onto a rolled μ/4 plate having a lagging axis in the longitudinal direction and comprising a polycarbonate derivative, under a pressure (0.8 kg/cm²) and under heating (120° C.) using a laminator (VP-II, manufactured by Taisei Laminator K. K.). Subsequently, the temporary support was peeled off at the interface with the thermoplastic resin layer to remove the temporary support. After exposure through a predetermined photomask, the thermoplastic resin layer and the interlayer were removed with an aqueous 1% triethanolamine solution. At this time, the photosensitive resin layer was substantially not developed. Then, the photosensitive resin layer was developed with an aqueous 1% sodium carbonate solution and unnecessary parts were removed to form a red picture element pattern on the λ/4 plate. On the λ/4 plate having formed thereon the red picture element pattern, the green photosensitive transfer material was laminated and the peeling, exposure and development were performed in the same manner as above to form a green picture element pattern. The same procedure was repeated for the blue and black photosensitive transfer materials. Thus, a color filter was formed on the λ/4 plate. In these steps, the temporary support exhibited satisfactory releasability from the thermoplastic resin layer. The obtained color filter had no dropping of picture elements, exhibited good adhesion to the substrate and was free of staining.

This λ/4 plate having formed thereon a color filter was set in a take-up type sputtering apparatus, where a 10 nm-thick SiOx gas barrier layer was formed on the color filter and a 150 nm-thick In₂O₃-base transparent electrode was further formed thereon. Thus, a λ/4 plate having a color filter layer, a gas barrier layer and a transparent electrode was obtained.

At this time, the retardation value (Re) of the λ/4 plate was measured at wavelengths of 450 nm, 550 nm and 590 nm and found to be 125.2 nm, 137.8 nm and 141.1 nm, respectively. This reveals that λ/4 was attained over a wide wavelength region.

A polyvinyl alcohol-base adhesive was coated on both surfaces of the polarizing element prepared above having an absorption axis inclined at 45° with respect to the longitudinal direction. The λ/4 plate obtained above in the polycarbonate side was laminated to one surface and a cellulose triacetate film (protective film) previously imparted with an antireflection layer/an antiglare layer in the side not having the antireflection layer/antiglare layer was laminated to the opposite surface by the roll-to-roll system. These were dried at 80° C. to obtain a 0.4 mm-thick plastic substrate for the display face side, having a function as a circularly polarizing plate with an effective width of 680 mm and having a color filter, a gas barrier layer, a transparent electrode and an antireflection layer/an antiglare layer.

The obtained plastic substrate realized an almost perfect function as a circularly polarizing plate. The surface resistivity of the transparent electrode was measured by the four probe method described in JIS H0602:1995 and found to be 15 Ω/□. Furthermore, the oxygen permeability of this plastic substrate was measured by the different pressure method and found to be 1.0 ml/m²·24 Hr·atm or less.

(Manufacture of Reflection-Type Liquid Crystal Display Device)

An opposite side glass substrate having formed thereon a TFT array comprising a reflective electrode and a 13.3-inch polysilicon for driving was prepared. In the electrode side of this glass substrate, a polyimide orientation film (SE-7992, produced by Nissan Chemicals Industries, Ltd.) was formed and subjected to a rubbing treatment. Thereon, the plastic substrate for the display face side prepared above, where a polyimide orientation film (SE-7992, produced by Nissan Chemicals Industries, Ltd.) was previously formed and subjected to a rubbing treatment, was superposed through a spacer such that the orientation films faced each other. Into the space between the substrates, liquid crystal (MLC-6252, produced by Merck) was injected to form a liquid crystal layer. Thus, a TN-type liquid crystal display device was manufactured.

To the thus-manufactured reflection-type liquid crystal display device, a rectangular wave voltage of 1 kHz was applied. The liquid crystal display device was evaluated using a spectrophotometer (CM-2002, manufactured by Minolta) by setting the white display at 1.5 V and the black display at 4.5 V, as a result, the white display was (x=0.31, y=0.33) and the black display was (x=0.31, y=0.30). Thus, it was confirmed that both the white display and the black display had no tint of color and neutral gray was displayed. Also, the liquid crystal display device exhibited an excellent color reproduction range and satisfactorily acted.

Furthermore, this liquid crystal display device was subjected to a heat cycle test at −20° C. and +70° C. More specifically, an operation of keeping the device at respective temperatures for 2 hours was repeated 250 cycles. In the cell of the tested liquid crystal display device, bubbles were not observed.

FIG. 1 is a schematic view showing the cross section of the reflection-type liquid crystal display device manufactured in Example 1 of the present invention.

### EXAMPLE 2

(Manufacture of Plastic Substrate in the Display Face Side)

On a 680 mm-width rolled λ/4 plate having a lagging axis in the longitudinal direction and comprising a polycarbonate derivative, where the retardation value (Re) at wavelengths of 450 nm, 550 nm and 590 nm was 126.0 nm, 138.8 nm and 142.1 nm, respectively, a color filter of RGB was formed by the photographic method described in JP-A-7-294714. Furthermore, a gas barrier layer and a transparent electrode were formed on this λ/4 plate having a color filter. Thus, a λ/4 plate having a color filter, a gas barrier layer and a transparent electrode was obtained.

The surface resistivity of the transparent electrode was measured by the four probe method described in JIS H0602:1995 and found to be 19 Ω/□. Furthermore, the oxygen permeability of this plastic substrate was measured by the different pressure method and found to be 1.0 ml/m²·24 Hr·atm or less.

(Manufacture of Liquid Crystal Display Cell)

An opposite side glass substrate having formed thereon a TFT array comprising a reflective electrode and a 13.3-inch polysilicon for driving was prepared. In the electrode side of this glass substrate, a polyimide orientation film (SE-7992, produced by Nissan Chemicals Industries, Ltd.) was formed and subjected to a rubbing treatment. Thereon, the plastic substrate for the display face side prepared above, where a polyimide orientation film (SE-7992, produced by Nissan Chemicals Industries, Ltd.) was previously formed and subjected to a rubbing treatment, was superposed through a spacer such that the orientation films faced each other. Into the space between the substrates, liquid crystal (MLC-6252, produced by Merck) was injected to form a liquid crystal layer. Thus, a liquid crystal cell was manufactured.

(Formation of Antireflection Layer/Antiglare Layer)

The antireflection layer/antiglare layer on the protective film of the polarizing plate was formed in the same manner as in Example 1 of JP-A-2001-100004. More specifically, Coating Solution A for an antiglare layer was coated on a triacetyl cellulose film (TAC-TD80U, trade name, produced by Fuji Photo Film Co., Ltd.) using a bar coater and dried at 120° C. Thereafter, an ultraviolet ray was irradiated at an illuminance of 400 mW/cm² in an irradiation amount of 300 mJ/cm² using an air cooled metal halide lamp (manufactured by Ai Graphics K. K.) of 160 W/cm to cure the coated layer and thereby form an antiglare layer having a thickness of about 1.5 μm. Thereon, a coating solution for a low refractive index layer was coated using a bar coater, dried at 80° C. and thermally cross-linked at 120° C. for 10 minutes to form a low refractive index layer having a thickness of 0.096 μm.

(Manufacture of Reflection-Type Liquid Crystal Display Device)

The polarizing plate imparted with the antireflection layer/antiglare layer and the hard coat layer was laminated to the TN-type liquid crystal cell prepared above such that the transmission axis of the polarizing plate made an angle of 45° with the in-plane lagging axis of the λ/4 plate. Thus, a TN-type liquid crystal display device was obtained.

To the thus-manufactured reflection-type liquid crystal display device, a rectangular wave voltage of 1 kHz was applied. The liquid crystal display device was evaluated using a spectrophotometer (CM-2002, manufactured by Minolta) by setting the white display at 1.5 V and the black display at 4.5 V, as a result, the white display was (x=0.32, y=0.33) and the black display was (x=0.31, y=0.31). Thus, it was confirmed that both the white display and the black display had no tint of color and neutral gray was displayed. Also, the liquid crystal display device exhibited an excellent color reproduction range and satisfactorily acted.

Furthermore, this liquid crystal display device was subjected to a heat cycle test at −20° C. and +70° C. More specifically, an operation of keeping the device at respective temperatures for 2 hours was repeated 250 cycles. In the cell of the tested liquid crystal display device, bubbles were not observed.

FIG. 2 is a schematic view showing the cross section of the reflection-type liquid crystal display device manufactured in Example 2 of the present invention.

### EXAMPLE 3

(Manufacture of Polarizing Element)

A polarizing element having an absorption axis inclined at 45° with respect to the longitudinal direction was manufactured in the same manner as in Example 1.

(Manufacture of Plastic Substrate in the Display Face Side)

A rolled λ/4 plate having a lagging axis in the longitudinal direction and comprising a polycarbonate derivative, where the retardation value (Re) at wavelengths of 450 nm, 550 nm and 590 nm was 125.0 nm, 138.8 nm and 142.4 nm, respectively, was set in a take-up type sputtering apparatus to form a 8 nm-thick SiOx gas barrier layer and further form thereon a 160 nm-thick In₂O₃-base transparent electrode. Thus, a λ/4 plate having a gas barrier layer and a transparent electrode was obtained.

A polyvinyl alcohol-base adhesive was coated on both surfaces of the polarizing element prepared above having an absorption axis inclined at 45° with respect to the longitudinal direction. The λ/4 plate obtained above in the polycarbonate side was laminated to one surface and a cellulose triacetate film previously imparted with an antireflection layer/an antiglare layer in the side not having the antireflection layer/antiglare layer was laminated to the opposite surface by the roll-to-roll system. These were dried at 80° C. to obtain a 0.4 mm-thick plastic substrate for the display face side, having a function as a circularly polarizing plate and having a gas barrier layer, a transparent electrode and an anti-reflection layer/antiglare layer.

The obtained plastic substrate realized an almost perfect function as a circularly polarizing plate. The surface resistivity of the transparent electrode was measured by the four probe method described in JIS H0602:1995 and found to be 14 Ω/□. Furthermore, the oxygen permeability of this plastic substrate was measured by the different pressure method and found to be 1.0 ml/m²·24 Hr·atm or less.

(Manufacture of Reflection-Type Liquid Crystal Display Device)

An opposite side glass substrate having formed thereon a TFT array comprising a reflective electrode and a 13.3-inch polysilicon driving circuit was prepared, where a color filter was provided on the TFT array by the transfer method in the same manner as in Example 1. In the electrode side of this glass substrate, a polyimide orientation film (SE-7992, produced by Nissan Chemicals Industries, Ltd.) was formed and subjected to a rubbing treatment. Thereon, the plastic substrate for the display face side prepared above, where a polyimide orientation film (SE-7992, produced by Nissan Chemicals Industries, Ltd.) was previously formed and subjected to a rubbing treatment, was superposed through a spacer such that the orientation films faced each other. Into the space between the substrates, liquid crystal (MLC-6252, produced by Merck) was injected to form a liquid crystal. layer. Thus, a TN-type liquid crystal display device was manufactured.

To the thus-manufactured reflection-type liquid crystal display device, a rectangular wave voltage of 1 kHz was applied. The liquid crystal display device was evaluated using a spectrophotometer (CM-2002, manufactured by Minolta) by setting the white display at 1.4 V and the black display at 4.4 V, as a result, the white display was (x=0.33, y=0.33) and the black display was (x=0.31, y=0.32). Thus, it was confirmed that both the white display and the black display had no tint of color and neutral gray was displayed. Also, the liquid crystal display device exhibited an excellent color reproduction range and satisfactorily acted.

Furthermore, this liquid crystal display device was subjected to a heat cycle test at −20° C. and +70° C. More specifically, an operation of keeping the device at respective temperatures for 2 hours was repeated 250 cycles. In the cell of the tested liquid crystal display device, bubbles were not observed.

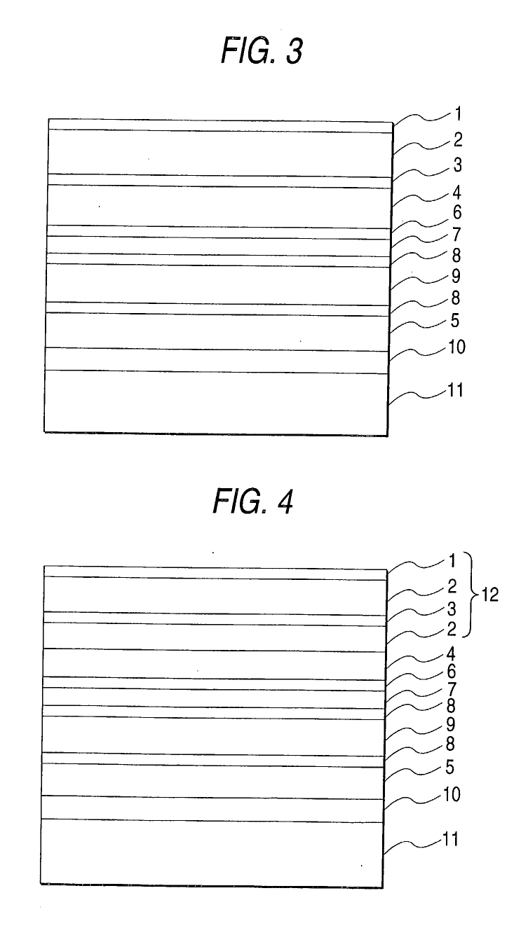

FIG. 3 is a schematic view showing the cross section of the reflection-type liquid crystal display device manufactured in Example 3 of the present invention.

### EXAMPLE 4

(Manufacture of Plastic Substrate in the Display Face Side)

On a rolled λ/4 plate having a lagging axis in the longitudinal direction and comprising a polycarbonate derivative, where the retardation value (Re) at wavelengths of 450 nm, 550 nm and 590 nm was 124.0 nm, 138.9 nm and 141.4 nm, respectively, a gas barrier layer and a transparent electrode were formed in the same manner as in Example 1 to obtain a λ/4 plate having a gas barrier layer and a transparent electrode.

The surface resistivity of the transparent electrode was measured by the four probe method described in JIS H0602:1995 and found to be 14 Ω/□. Furthermore, the oxygen permeability of this plastic substrate was measured by the different pressure method and found to be 1.0 ml/m²·24 Hr·atm or less.

(Manufacture of Liquid Crystal Display Cell)

An opposite side glass substrate having formed thereon 4 sets of TFT array comprising a reflective electrode and a 13.3-inch polysilicon for driving was prepared, where a color filter was further provided on the TFT array by the transfer method described in JP-A-5-80503. In the electrode side of this glass substrate, a polyimide orientation film (SE-7992, produced by Nissan Chemicals Industries, Ltd.) was formed and subjected to a rubbing treatment. Thereon, the plastic substrate for the display face side prepared above, where a polyimide orientation film (SE-7992, produced by Nissan Chemicals Industries, Ltd.) was previously formed and subjected to a rubbing treatment, was superposed through a spacer such that the orientation films faced each other. Into the space between the substrates, liquid crystal (MLC-6252, produced by Merck) was injected to form a liquid crystal layer. Thus, a TN-type liquid crystal cell was manufactured.

(Manufacture of Reflection-Type Liquid Crystal Display Device)

A polarizing plate imparted with an antireflection layer/antiglare layer and a hard coat layer was laminated to the TN-type liquid crystal cell prepared above such that the transmission axis of the polarizing plate made an angle of 45° with the in-plane lagging axis of the λ/4 plate. Thus, a TN-type liquid crystal display device was obtained.

To the thus-manufactured reflection-type liquid crystal display device, a rectangular wave voltage of 1 kHz was applied. The liquid crystal display device was evaluated using a spectrophotometer (CM-2002, manufactured by Minolta) by setting the white display at 1.4 V and the black display at 4.4 V, as a result, the white display was (x=0.32, y=0.33) and the black display was (x=0.31, y=0.32). Thus, it was confirmed that both the white display and the black display had no tint of color and neutral gray was displayed. Also, the liquid crystal display device exhibited an excellent color reproduction range and satisfactorily acted.

Furthermore, this liquid crystal display device was subjected to a heat cycle test at −20° C. and +70° C. More specifically, an operation of keeping the device at respective temperatures for 2 hours was repeated 250 cycles. In the cell of the tested liquid crystal display device, bubbles were not observed.

FIG. 4 is a schematic view showing the cross section of the reflection-type liquid crystal display device manufactured in Example 4 of the present invention.

As is apparent from these Examples, according to the present invention, a reflection-type liquid crystal display device particularly for potable use can be obtained, which is a liquid crystal display device being lightweight, having flexibility and undergoing less breakage of substrate. Also, an optical laminate in the display side for manufacturing the liquid crystal display device can be obtained.

Furthermore, it is revealed that by using a polarizing plate having a transmission axis inclined at 45° with respect to the longitudinal direction, the polarizing plate can be effectively used.

### EXAMPLE 5

An opposite side glass substrate of 550 mm×650 mm, having formed thereon 4 sets of TFT array comprising a reflective electrode and a 13.3-inch cell polysilicon for driving was prepared. In the electrode side of this glass substrate, a polyimide orientation film (SE-7992, produced by Nissan Chemicals Industries, Ltd.) was formed and subjected to a rubbing treatment and then, a sealing agent for 4 sets of 13.3-inch cell was coated. Thereon, the plastic substrate of 550 mm×650 mm prepared in Example 1 having previously formed thereon a color filter and a transparent electrode and having a function as a circularly polarizing plate, where a polyimide orientation film (SE-7992, produced by Nissan Chemicals Industries, Ltd.) was formed and subjected to a rubbing treatment, was superposed through a spacer such that the orientation films faced each other and the sealing agent was cured. Then, liquid crystal (MLC-6252, produced by Merck) was injected to form a liquid crystal layer and sealed. Thus, a liquid crystal cell containing 4 sets of 13.3-inch TN-type liquid crystal cell in the area of 550 mm×650 mm was manufactured. The obtained liquid crystal cell was cut and 4 sets of 13.3-inch reflection-type liquid crystal cell were obtained.

### EXAMPLE 6

An opposite side glass substrate of 650 mm×830 mm, having formed thereon 9 sets of TFT array comprising a reflective electrode and a 12.1-inch cell polysilicon for driving was prepared. In the electrode side of this glass substrate, a polyimide orientation film (SE-7992, produced by Nissan Chemicals Industries, Ltd.) was formed and subjected to a rubbing treatment and then, a sealing agent for 9 sets of 12.1-inch cell was coated. Thereon, a plastic substrate of 650 mm×830 mm having previously formed thereon a color filter and a transparent electrode and having a function as a phase difference plate and thereon, where a polarizing plate was laminated and a polyimide orientation film (SE-7992, produced by Nissan Chemicals Industries, Ltd.) was formed and subjected to a rubbing treatment, was superposed through a spacer such that the orientation films faced each other and the sealing agent was cured. Subsequently, the laminate was cut into 9 sets. Then, liquid crystal (MLC-6252, produced by Merck) was injected to form a liquid crystal layer and sealed. Thus, 9 sets of 12.1-inch liquid crystal cell were obtained from a pair of substrates in a size of 650 mm×830 mm.

### EXAMPLE 7

An opposite side glass substrate of 600 mm×720 mm, having formed thereon 4 sets of TFT array comprising a reflective electrode and a 12.1-inch cell polysilicon for driving was prepared. In the electrode side of this glass substrate, a polyimide orientation film (SE-7992, produced by Nissan Chemicals Industries, Ltd.) was formed and subjected to a rubbing treatment and then, a sealing agent for 6 sets of 12.1-inch cell was coated. Thereon, a plastic substrate of 600 mm×720 mm having previously formed thereon a color filter and a transparent electrode, where a polyimide orientation film (SE-7992, produced by Nissan Chemicals Industries, Ltd.) was formed and subjected to a rubbing treatment, was superposed through a spacer such that the orientation films faced each other and the sealing agent was cured. Subsequently, a phase difference plate comprising cellulose acetate and a polarizing plate were laminated using a pressure sensitive adhesive to impart a function as a circularly polarizing plate. Into the space between the substrates, liquid crystal (MLC-6252, produced by Merck) was injected to form a liquid crystal layer and sealed. Thus, a TN-type liquid crystal cell containing 6 sets of 12.1-inch TN-type liquid crystal cell in the area of 600 mm×720 mm was manufactured. Then, the cell was cut and 6 sets of 12.1-inch reflection-type liquid crystal cell were obtained.

### EXAMPLE 8

An opposite side glass substrate of 550 mm×650 mm, having formed thereon 4 sets of TFT array comprising a reflective electrode and a 4-inch cell polysilicon for driving was prepared. In the electrode side of this glass substrate, a polyimide orientation film (SE-7992, produced by Nissan Chemicals Industries, Ltd.) was formed and subjected to a rubbing treatment. Thereafter, a sealing agent for 60 sets of 4-inch cell was coated. Thereon, a plastic substrate of 550 mm×650 mm having previously formed thereon a color filter and a transparent electrode and having a function as a circularly polarizing plate, where a polyimide orientation film (SE-7992, produced by Nissan Chemicals Industries, Ltd.) was formed and subjected to a rubbing treatment, was superposed through a spacer such that the orientation films faced each other and the sealing agent was cured. Then, the laminate was cut into 60 sets. Thereafter, liquid crystal (MLC-6252, produced by Merck) was injected to form a liquid crystal layer and sealed. Thus, a TN-type liquid crystal cell of 550 mm×650 mm was manufactured with good efficiency.

### EXAMPLE 9

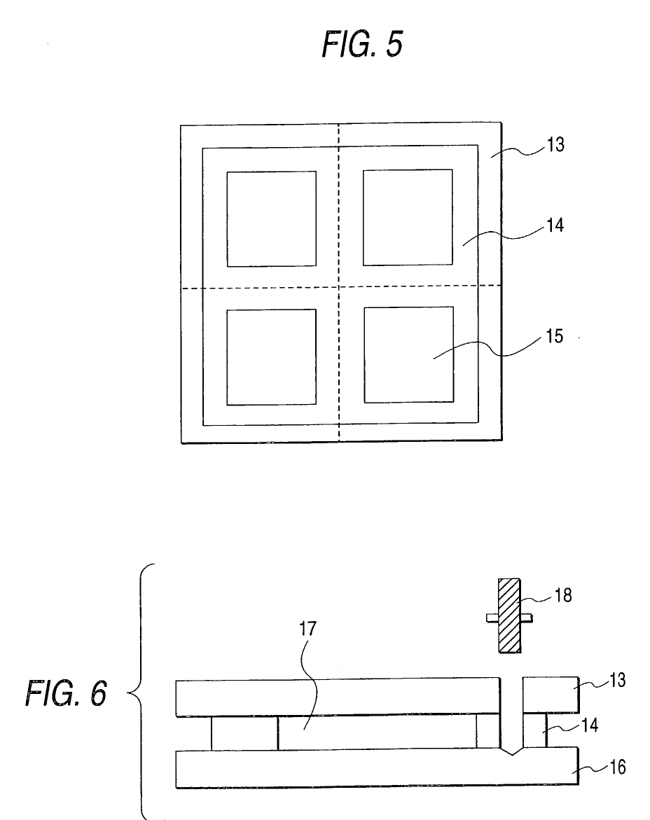

A 0.4 mm-thick plastic substrate was prepared as the substrate in the display face side. Then, a 0.7 mm-thick glass substrate having formed thereon a TFT array comprising a reflective electrode and polysilicon for driving was prepared as the opposite side substrate. After coating a sealing agent, these substrates were laminated through a polyimide orientation film and liquid crystal. Thereafter, the sealing agent was cured to obtain a substrate containing 4 sets of liquid crystal cell, where the region constituting the picture plane part of the liquid crystal cell comprising a glass substrate and a plastic substrate was surrounded by a sealing agent. FIG. 5 shows a plan view of the substrate. The portion to be cut is shown by a broken line.

Using a cutting grindstone, the portion on the sealing agent in the display face side was cut and at the same time, the glass surface was scribed to introduce a scratch having a depth of about 10 μm. FIG. 6 is a schematic view showing the cutting step of cutting the plastic substrate and introducing a scratch on the glass substrate. In FIG. 6, only a part of the liquid crystal device of FIG. 5 is shown in a simple manner.

After this cutting step, a pressure was applied to the scratch on the glass surface to divide the substrate and thereby, 4 sets of lightweight liquid crystal display cell could be obtained with good efficiency.

Industrial Applicability

According to the present invention, a reflection-type liquid crystal display device, particularly for potable use, can be obtained, which is a liquid crystal display device being lightweight, having flexibility and undergoing less breakage of substrate. Also, an optical laminate in the display side for manufacturing the liquid crystal display device can be obtained.

Furthermore, it is revealed that by using a polarizing plate having a transmission axis inclined at 45° with respect to the longitudinal direction, the polarizing plate can be effectively used.

1. A liquid crystal display device comprising: a liquid crystal layer; and two substrates each having an electrode, in which the liquid crystal layer is interposed between the two substrates, wherein at least the substrate in the display face side is a plastic substrate having an optical anisotropy.

2. The liquid crystal display device as claimed in claim 1, wherein the plastic substrate having optical anisotropy has a function as a phase difference plate.

3. The liquid crystal display device as claimed in claim 2, wherein the phase difference plate is a λ/4 plate.

4. The liquid crystal display device as claimed in claim 3, wherein the λ/4 plate has the retardation value (Re450) of from 60 to 135 nm which is measured at a wavelength of 450 nm, the λ/4 plate has the retardation value (Re590) of from 100 to 170 nm which is measured at a wavelength of 590 nm, and the λ/4 plate satisfy the relationship of Re590−Re450≧2 nm.

5. The liquid crystal display device as claimed in any one of claims 1 to 4, which further comprises a polarizing plate, in which the polarizing plate is laminated to the plastic substrate having an optical anisotropy.

6. The liquid crystal display device as claimed in any one of claims 1 to 5, wherein the electrode on the plastic substrate having an optical anisotropy in the display face side is a transparent electrode.

7. The liquid crystal display device as claimed in any one of claims 1 to 6, which further comprises a gas barrier layer, in which the gas barrier layer is provided on the plastic substrate having an optical anisotropy in the display face side.

8. The liquid crystal display device as claimed in any one of claims 1 to 7, which further comprises a color filter layer, in which the color filter layer is provided on the plastic substrate having an optical anisotropy in the display face side.

9. The liquid crystal display device as claimed in any one of claims 1 to 7, which further comprises a color filter layer, in which the color filter layer is provided on the substrate on the opposite side of the display face.

10. The liquid crystal display device as claimed in claim 9, wherein the color filter layer is provided on a driving circuit.

11. The liquid crystal display device as claimed in any one of claims 1 to 10, wherein the outermost layer in the display face side is subjected to at least one of an antireflection treatment and an antiglare treatment.

12. The liquid crystal display device as claimed in claim 8, wherein the color filter layer is provided between the polarizing plate and the transparent electrode.

13. The liquid crystal display device as claimed in claim 7, wherein the gas barrier layer is provided in the side closer to the liquid crystal layer than one of a circularly polarizing plate and a color filter.

14. The liquid crystal display device as claimed in any one of claims 1 to 5, wherein a transparent electrode, a gas barrier layer, a color filter layer and at least one of an antireflection and antiglare layer are provided on the plastic substrate having an optical anisotropy in the display face side.

15. The liquid crystal display device as claimed in claim 14, wherein all layers in the side closer to the display face than the liquid crystal layer have a thickness of 0.1 to 1.0 mm in total.

16. The liquid crystal display device as claimed in any one of claims 1 to 15, which is a reflection-type liquid crystal display device, wherein the electrode on the opposite side of the display face is a reflective electrode.

17. An optical laminate comprising a plastic substrate having thereon at least a color filter layer, said plastic substrate having an optical anisotropy.

18. The optical laminate as claimed in claim 17, which further comprises at least one of an electrode, a gas barrier layer, at least one of an antireflection layer and an antiglare layer, and a polarizing element.
